(19) United States
(12) Patent Application Publication
(10) Pub. No.: US 2007/0205731 A1
(43) Pub. Date: Sep. 6, 2007

(54) Methods and systems for dynamically braking an electronically commutated motor

(75) Inventor: Brian L. Beifus, Ft. Wayne, IN (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Regal-Beloit Corporation

(21) Appl. No.: 11/364,919

(22) Filed: Mar. 1, 2006

(51) Int. Cl. H02P 3/00

(52) U.S. Cl. 318/362

(57) ABSTRACT

A method for applying braking to an electronically commutated motor that includes a switching circuit electrically coupled to one or more windings is described. The method comprises operating the switching circuit to remove power from the windings of the electronically commutated motor, determining when the rotation of a rotor of the electronically commutated motor has decreased to a predetermined speed, and operating the switching circuit to interconnect the windings of the electronically commutated motor such that currents passing through the windings are dissipated through components of the switching circuit and the windings.

### BACKGROUND OF THE INVENTION

This invention relates generally to electronically commutated motor (ECM) operation, and more specifically to methods and systems for braking an ECM, which is sometimes referred to an a brushless DC motor.

When a brushless DC motor stops by coasting, that is slowly decreasing from rotation at an operated speed to a stop, magnetic forces in the air gap can excite resonances of the motor mount and sheet metal of the blower as the pole passing rate matches the resonant frequencies of the motor mount and sheet metal. Since coast down takes some a certain amount of time, based on magnetic and frictional forces, there is more opportunity for these resonances to be heard. In a office setting or other application, such noises may be the source of some disturbance to those within such a setting.

A second problem concerns assembly line testing of the brushless DC motor. For example, if repeated stops and restarts of the motor are required, for example, as in a balancing operation, reducing the stopping time can greatly improve the throughput through the testing area.

A third problem occurs when the blower or fan driven by the ECM is in a situation where a pressure differential causes the blower, and hence the ECM, to rotate in the reverse direction when the motor is in a “OFF” state. In certain applications, this reverse rotation speed may be quite high. When the blower and motor are in this rapid reverse rotation situation, restarting certain ECMs may by problematic.

### BRIEF DESCRIPTION OF THE INVENTION

In one aspect, a method for applying braking to an electronically commutated motor that includes a switching circuit electrically coupled to one or more windings is provided. The method comprises operating the switching circuit to remove power from the windings of the electronically commutated motor, determining when the rotation of a rotor of the electronically commutated motor has decreased to a predetermined speed, and operating the switching circuit to interconnect the windings of the electronically commutated motor such that currents passing through the windings are dissipated through components of the switching circuit and the windings.

In another aspect, an electronically commutated motor is provided that comprises a rotor attached to a blower or fan, a plurality of windings for causing a rotation of the rotor, and a switching circuit. The switching circuit is operable to selectively couple the windings to a power source. The switching circuit is further operable to remove power from the windings and interconnect the windings to one another such that that currents passing through the windings are dissipated within components of the control circuit and the windings.

In another aspect, a control unit for an electronically commutated motor having a plurality of windings operable for rotating a rotor is provided. The control unit comprises a processing device and a switching circuit. The processor is programmed to operate the switching circuit. The switching circuit is operable to remove power from the windings of the electronically commutated motor and interconnect the windings of the electronically commutated motor such that currents passing through the windings are dissipated through components of the switching circuit and the windings.

### BRIEF DESCRIPTION OF THE DRAWINGS

FIG. 1 is an exploded view of an integrated electronically commutated motor (ECM) and control circuit assembly.

FIG. 2 is a fully assembled view of the ECM and control circuit assembly of FIG. 1.

FIG. 3 is an exploded partial view of an ECM having a control circuit that fits into the main chassis of the ECM.

FIG. 4 is a block diagram of a control circuit of an ECM.

FIG. 5 is a schematic diagram illustrating an operational equivalent of a programmed controller applying power to the windings of an ECM.

FIG. 6 is the schematic of FIG. 5 illustrating the operational equivalent of one dynamic braking embodiment.

### DETAILED DESCRIPTION OF THE INVENTION

Described herein are methods and systems for using dynamic braking to reduce the time required to slow rotation of an electronically commutated motor (ECM) to a stop. As is known in the art, ECMs are routinely used to power blowers and fans. However, and as described above, allowing an ECM to coast to a stop after removal of power has drawbacks such as passing through resonant frequencies of various components of the ECMs. In addition, reverse rotation in an inverse pressure situation also is a cause for concern. The principles for dynamic braking of an ECM (e.g., a brushless DC motor) is known, however applying such principles to a direct drive ECM blower, to actively hold an ECM in a stopped position, may also provide further advantages to a user.

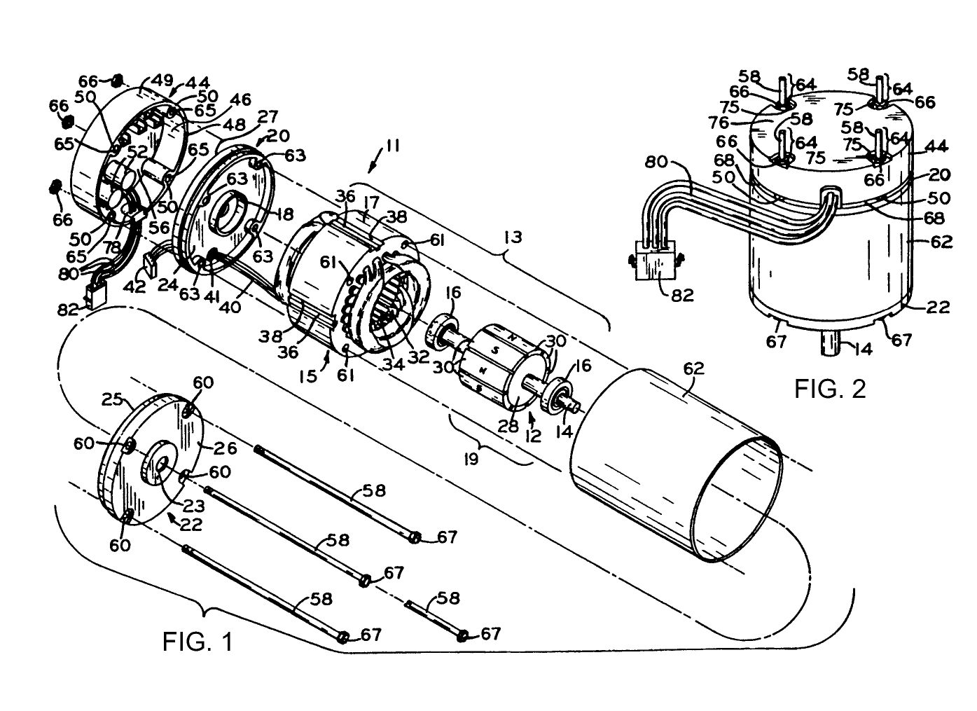

Referring to the drawings, and more particularly to FIGS. 1 and 2, reference character 11 generally designates an integrated electronically commutated motor and control circuit assembly. Motor assembly 11 comprises a brushless electronically commutated DC motor 13 having a stationary assembly 15 including a stator or core 17 and a rotatable assembly 19 including a permanent magnet rotor 12 and a shaft 14. A fan (not shown) or other means to be driven such as means for moving air through an air handling system engages the shaft 14. Specifically, motor assembly 11 is for use in combination with an air handling system such as an air conditioning system including a fan for blowing air over cooling coils for supplying the cooled air to a building.

Rotor 12 is mounted on and keyed to the shaft 14 journaled for rotation in conventional bearings 16. The bearings 16 are mounted in bearing supports 18 integral with a first end member 20 and a second end member 22. The end members 20 and 22 are substantially flat and parallel to each other. The end members 20 and 22 have inner facing sides 24, 25 between which the stationary assembly 15 and the rotatable assembly 19 are located. Each end member 20 and 22 has an outer side 26, 27 opposite its inner side 24, 25. Additionally, second end member 22 has an aperture 23 for the shaft 14 to pass through and extend out from the outer side 26.

The rotor 12 comprises a ferromagnetic core 28 and is rotatable within the bore of stator 17. Eight essentially identical magnetic material elements or relatively thin arcuate segments 30 of permanent magnet material, each providing a relatively constant flux field, are secured, for example, by adhesive bonding to rotor core 28. The segments 30 are magnetized to be polarized radially in relation to the rotor core 28 with adjacent segments 30 being alternately polarized as indicated. While magnets 30 on rotor 12 are illustrated for purposes of disclosure, it is contemplated that other rotors having different constructions and other magnets different in both number, construction, and flux fields may be utilized with such other rotors within the scope of the invention so as to meet at least some of the objects thereof.

Stationary assembly 15 comprises a plurality of winding stages 32 adapted to be electrically energized to generate an electromagnetic field. Stages 32 are coils of wire wound around teeth 34 of the laminated stator core 17. The core 17 may be held together by four retainer clips 36, one positioned within each notch 38 in the outer surface of the core 17. Alternatively, the core 17 may be held together by other suitable means, such as for instance welding or adhesively bonding, or merely held together by the windings, all as will be understood by those skilled in the art. The winding end turns extend beyond the stator end faces and winding terminal leads 40 are brought out through an aperture 41 in the first end member 20 terminating in a connector 42. While stationary assembly 15 is illustrated for purposes of disclosure, it is contemplated that other stationary assemblies of various other constructions having different shapes and with different number of teeth may be utilized within the scope of the invention so as to meet at least some of the objects thereof.

Motor assembly 11 further includes a cap 44 which is mounted on the rear portion of the motor assembly 11 to enclose within the cap 44 control means 46 for the motor 13. The cap 44 includes an edge 48 having a plurality of spacing elements 50 projecting therefrom which engage the outer side 27 of the first end member 20. Cap 44 includes a substantially annular side wall 49 with the top of the side wall 49 forming edge 48. The control means 46 is positioned adjacent the outer side 27 of the first end member 20. The control means 46 includes a plurality of electronic components 52 and a connector (not shown) mounted on a component board 56, such as a printed circuit board. The control means 46 is connected to the winding stages 32 by interconnecting connector 42 and connector 54. The control means 46 applies a voltage to one or more of the winding stages 32 at a time for commutating the winding stages 32 in a preselected sequence to rotate the rotatable assembly 19 about an axis of rotation.

Connecting elements 58 comprising a plurality of bolts pass through bolt holes 60 in the second end member 22, bolt holes 61 in core 17, bolt holes 63 in first end member 20, and bolt holes 65 in cap 44. The head 67 of the connecting elements 58 engage the second end member 22. The connecting elements 58 are adapted to urge the second end member 22 and the cap 44 toward each other thereby supporting the first end member 20, the stationary assembly 15, and the rotatable assembly 19 therebetween. Additionally, a housing 62 may be positioned between the first end member 20 and the second end member 22 for enclosing and protecting the stationary assembly 15 and the rotatable assembly 10.

Electronically commutated motor 13 as described herein merely for purposes of disclosure is an eight rotor-pole motor, but it will be understood that the electronically commutated motor of this invention may include any even number of rotor poles and the number of stator poles are a multiple of the number of rotor poles, for example, the number of stator poles may be based on the number of phases. In one exemplary embodiment not shown in the Figures, a three-phase ECM includes six rotor pole pairs and 18 stator poles.

The motor assembly 11 according to the invention operates in the following manner. When the winding stages 32 are energized in a temporal sequence three sets of eight magnetic poles are established that will provide a radial magnetic field which moves clockwise or counterclockwise around the core 17 depending on the preselected sequence or order in which the stages are energized. This moving field intersects with the flux field of the magnet 30 poles to cause the rotor to-rotate relative to the core 17 in the desired direction to develop a torque which is a direct function of the intensities or strengths of the magnetic fields.

The winding stages 32 are commutated without brushes by sensing the rotational position of the rotatable assembly 19 as it rotates within the core 17 and utilizing electrical signals generated as a function of the rotational position of the rotor 12 sequentially to apply a DC voltage to each of the winding stages 32 in different preselected orders or sequences that determine the direction of the rotation of the rotor 12. Position sensing may be accomplished by a position-detecting circuit responsive to the back electromotive force (EMF) to provide a simulated signal indicative of the rotational position of the rotor 12 to control the timed sequential application of voltage to the winding stages 32 of the motor 13. Other means of position sensing may also be used.

FIG. 2 illustrates the fully assembled motor assembly 11. Connecting elements 58 pass through the second end member 22, the stationary assembly 15, the first end member 20, and the cap 44. The connecting elements 58 have a portion 64 which projects laterally from the cap 44. Portion 64 is adapted to engage a support structure (not shown) for supporting the motor assembly 11. The connecting elements 58 may be secured in place by placing a nut 66 engaging the threads on each of the portions 64 of the connecting elements 58. A wiring harness 80 and connector 82 are utilized to connect motor assembly 11 to an electrical power source.

Spacing elements 50 when engageable with the outer side 27 of the first end member 20 form air gaps 68 between the spacing elements 50, the edge 48, and the outer side 27. The air gaps 68 permit flow through the cap 44 thereby dissipating heat generated by the motor assembly 11. Additionally, if the motor assembly 11 is exposed to rain the air gaps 68 permit rain which has entered the cap 44 to flow out of the cap 44 via the air gaps 68.

Indentations 75 are formed in a bottom 76 of the cap 44 which provide a space for a tool (not shown) to fit in to tighten the nuts 66. The indentations 75 also allow the nuts 66 to be mounted on the connecting elements 58 flush with the bottom 76 of the cap 44.

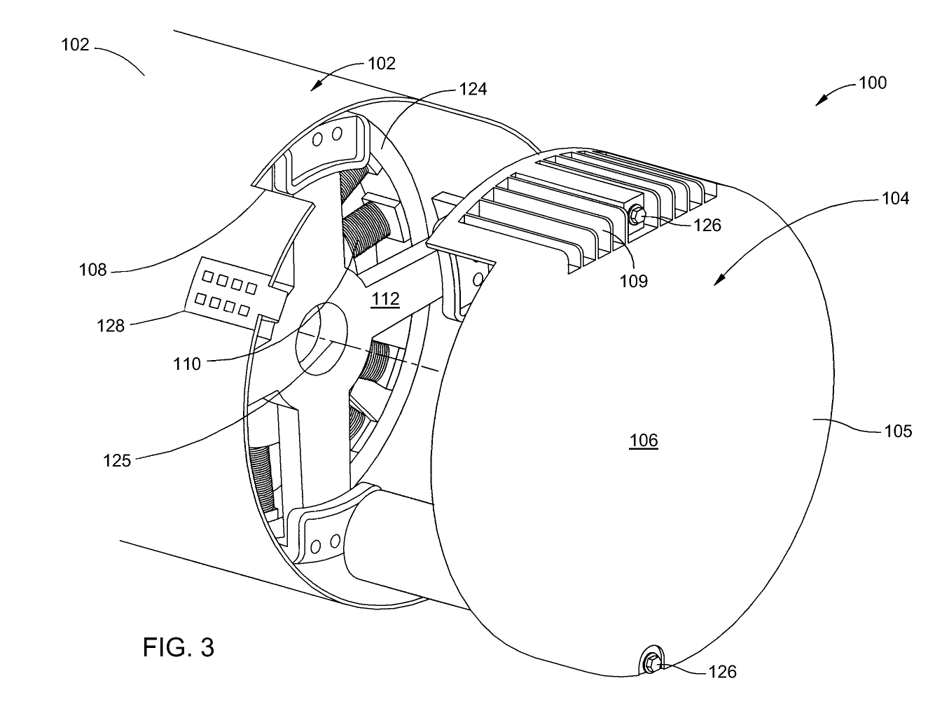

FIG. 3 is an exploded end view of an alternative embodiment for an ECM 100. Motor 100 includes a motor enclosure 102 and a motor control unit 104 configured for attachment to motor enclosure 102. A chassis 105 of motor control unit 104 serves as an end shield 106 for motor 100. Motor enclosure 102 also includes a slot 108 which engages a heat sink 109 formed in chassis 105 as further described below. While motor control unit 104 includes chassis 105, motor 100 is configured such that motor enclosure 102 provides substantially all of the enclosure for motor control unit 104. Within motor enclosure 102 are windings 110 of motor 100 and a mid shield 112 configured for placement between windings 110 and motor control unit 104.

The placement and configuration of mid shield 112 allows motor control unit 104 of motor 100 to be removed and replaced without disruption or displacement of a motor winding assembly 124 which includes windings 110 of motor 100. As illustrated, motor enclosure 102 is configured to form a part of the enclosure for motor control unit 104, along with end shield 106, allowing for a one-piece enclosure configuration. Mid shield 112 is also configured to meet any airflow, voltage clearances and assembly height limitations imposed on motor 100.

In one embodiment, as illustrated, mid shield 112 fits precisely with respect to a centerline 125 of motor 100 and further aligns with two bolts 126 that pass through end shield 106 of motor control unit 104 to clamp and secure mid shield 112 and motor control unit 104 within motor enclosure 102. This alignment and symmetry remain even when chassis 105 containing the electronics of motor control unit 104 is removed. Retaining the alignment and symmetry within enclosure 102 is important as it lowers a replacement cost of motor control unit 104 in the field. Mid shield 112 also contributes to a lower material cost for motor 100, because with mid shield 112, motor enclosure 102 is utilized as a part of the containment enclosure for portions of motor control unit 104 as shown in FIG. 3, decreasing the size of motor 100 as compared to motor 11 (shown in FIGS. 1 and 2). Additionally, such a configuration allows for a placement of a power connector 128 that is flush with chassis 102.

Utilization of mid shield 112 allows motor control unit 104 to be removed from enclosure 102 without disturbing the rest of the motor assembly, for example, windings 110. The non-disturbance is obtained by using mid shield 112 to secure a bearing that engages a motor shaft (neither shown in FIG. 1) of motor 100. Therefore, enclosure 102 is additionally configured to provide any required clearances for the electrical components (e.g., motor control unit 104) of motor 100 to allow disengagement of motor control unit 104 from motor 100.

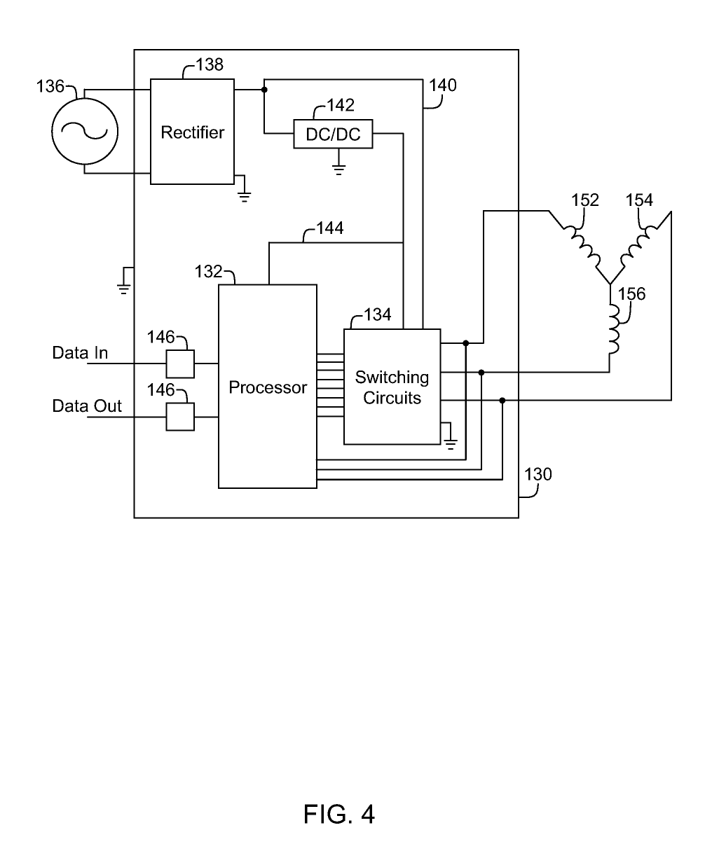

FIG. 4 is a simplified block diagram of an ECM control circuit 130 that includes a processor 132 and switching circuits 134. Typically, an ECM is powered utilizing an AC voltage 136 that is rectified by a rectifier 138 to provide a high voltage DC source 140 to power the windings of an ECM. A DC/DC converter 142 is utilized to provide an operating voltage 144 for processor 132 and switching circuits 134. Isolation devices 146 are utilized to electrically isolate processor 132 from external devices while allowing communications to and from the external devices. As further described below, processor 132 is programmed to operate switching circuits 134 to selectively connect (and disconnect) windings 152, 154, and 156 of the ECM to the high voltage DC source 140 to cause a rotation of a rotor of the ECM. Additionally, and in one embodiment, processor 132 is programmed to operate switching circuits 134 such that the high voltage DC source 140 is removed from windings 152, 154, and 156. In the embodiment, processor 132 is further configured to provide braking for the ECM by operating switching circuits 134 such that currents generated within the windings 152, 154, and 156 after removal of the high voltage DC source 140 is able to be dissipating through the windings 152, 154, and 156 and certain components of switching circuits 134.

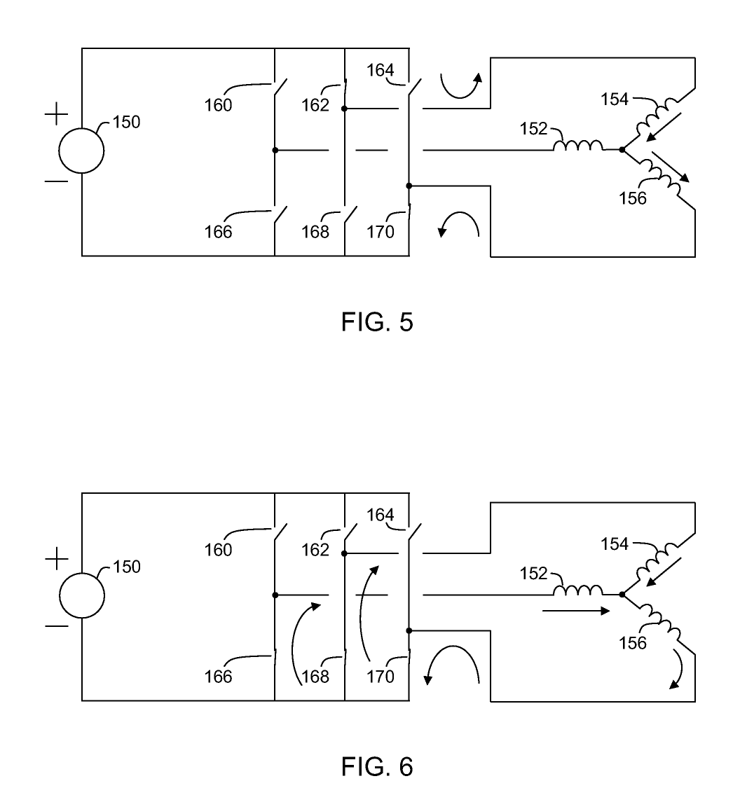

FIG. 5 is a simple schematic diagram illustrating application of a DC voltage supply 150 (analogous to DC source 140 in FIG. 4) to windings 152, 154, and 156 respectively, of a three phase ECM. Specifically, operation of switching circuits 134, described with respect to FIG. 4 above, may emulate the operation of a number of switches, illustrated as switches 160, 162, 164, 166, 168, and 170 in FIG. 5. To provide a current though windings 154 and 156, switches 162 and 170 are closed. Specifically, a current output by DC voltage supply 150 passes through switch 162, through windings 154 and 156, through switch 170 and back to the negative terminal of supply 150. Of course, those skilled in the art will appreciate by selective opening and closing switches 160-170, currents are passed through windings 152, 154, and 156 to cause rotation within the ECM. As mentioned above, ECMs do not incorporate such switches. Rather, the switches are illustrative of the operation of programmable electronics (i.e., processor 132 and switching circuits 134) within the control circuit of the ECM.

FIG. 6 illustrates dynamic braking of the three phase ECM utilizing the switch illustration of FIG. 5. More specifically, dynamic braking of the ECM is accomplished by turning on some of the power switches 160-170 (e.g., operating the switching circuits 134) in such a way that current does not flow from supply 150. Rather, by opening switches 160-164 and closing switches 166-107, current generated from collapsing electromagnetic fields around the windings can circulate through one or more of the remaining motor windings. In the illustrated case, closing switches 166-170 allows the generated energy to dissipated in the resistance of windings 152-156 and switches 166-170 and is referred to herein as dynamic braking. As described above, switches 160-170 are illustrative of the electronic components within the switching circuits 134 of the ECM. Similarly, the operational equivalent of closing switches 160-164 would allow the same dissipation of energy (e.g., dynamic braking) as does the operational equivalent of closing of switches 166-170.

In one embodiment, the ECM is programmed to delay the above described dynamic braking procedure until the speed of rotation is below a predetermined speed. The speed of rotation is determined utilizing the above described preprocessor 132. Waiting to apply the dynamic braking until the motor slows down to a predetermined speed limits the peak braking currents that will be passed through the switching circuits 134 circuit and windings 152, 154, and 156. After a predetermined time has elapsed, the dynamic braking condition is removed, allowing power to be removed from the control circuit if desired. Alternatively, the dynamic braking condition can be maintained until the motor is required to start again. Maintaining the dynamic braking is useful in the case where the blower or fan being powered by the ECM experiences a pressure differential that would cause reverse rotation if the blower was free to turn, since starting an ECM having a reverse rotating condition is more difficult than starting a motor that is at a standstill.

The above described embodiments provide an electronically commutated motor (ECM), which may or may not be connected to a blower or fan that uses dynamic braking as herein described to reduce audible noise associated with slowing of the motor after removal of power. In addition, the described ECM provides a solution to the known problem of reverse rotation, and reduces assembly line test time by braking to a stop or slower speed rather than coasting to the stop or slower speed.

While the invention has been described in terms of various specific embodiments, those skilled in the art will recognize that the invention can be practiced with modification within the spirit and scope of the claims.

1. A method for applying braking to an electronically commutated motor that includes a switching circuit electrically coupled to one or more windings, said method comprising:
operating the switching circuit to discontinue a supply of external power provided to the windings of the electronically commutated motor;
determining when the rotation of a blower or fan attached to a rotor of the electronically commutated motor has decreased to a predetermined speed; and
operating the switching circuit, once the rotation of the blower or fan is determined to have decreased to a predetermined speed, to interconnect the windings of the electronically commutated motor such that currents passing through the windings are dissipated through components of the switching circuit and the windings.

2. A method according to claim 1 wherein determining when the rotation of a rotor of the electronically commutated motor has decreased to a predetermined speed comprises using the switching circuit to determine a speed of rotation.

3. A method according to claim 1 further comprising:
determining, using the switching circuit, when the rotor of the electronically commutated motor has stopped rotating; and
removing power from the switching circuit.

4. A method according to claim 1 wherein operating the switching circuit to interconnect the windings of the electronically commutated motor further comprises maintaining an interconnection between the windings until a rotation of the rotor of the electronically commutated motor is desired.

5. A method according to claim 1 wherein operating the switching circuit to interconnect the windings comprises configuring a processor to control operation of the switching circuit, the switching circuit coupled to the windings.

6. An electronically commutated motor comprising:
a rotor attached to a blower or fan;
a plurality of windings for causing a rotation of said rotor; and
a switching circuit operable to selectively couple said windings to a power source, said switching circuit further operable to discontinue a supply of external power provided to said windings and interconnect said windings to one another such that currents passing through said windings are dissipated within components of said switching circuit and said windings, causing a dynamic braking condition.

7. An electronically commutated motor according to claim 6 further comprising a processor programmed to control operation of said switching circuit.

8. An electronically commutated motor according to claim 7 wherein said processor is programmed to determine when the rotation of a rotor of said electronically commutated motor has decreased to a predetermined speed before interconnecting said windings.

9. An electronically commutated motor according to claim 7 wherein said processor is programmed to determine when a rotor of said electronically commutated motor has stopped rotating.

10. An electronically commutated motor according to claim 7 wherein said processor is programmed to cause said switching circuit to maintain the interconnection between said windings until said processor determines that rotation of the rotor of said electronically commutated motor is desired.

11. A control unit for an electronically commutated motor having a plurality of windings operable for rotating a rotor, said control unit comprising:
a processing device; and
a switching circuit, said processor programmed to operate said switching circuit, said switching circuit operable to discontinue a supply of external power provided to the windings of the electronically commutated motor and interconnect the windings of the electronically commutated motor such that currents passing through the windings are dissipated through components of said switching circuit and the windings, causing a dynamic braking condition.

12. A control unit according to claim 11 wherein said processing device comprises an input configured to receive a signal representative of rotor rotation speed, said processing device programmed to determine when the rotation of a rotor of the electronically commutated motor has decreased to a predetermined speed after power has been removed from the windings.

13. A control unit according to claim 11 wherein said processing device comprises an input configured to receive a signal representative of rotor rotation speed, said processing device programmed to determine when the rotation of a rotor of the electronically commutated motor has decreased to a stop after power has been removed from the windings.

14. A control unit according to claim 11 wherein said processor is programmed to cause said switching circuit to maintain the interconnection between the windings until said processor determines that rotation of the rotor of the electronically commutated motor is desired.
